(19) United States
(12) Patent Application Publication
(10) Pub. No.: US 2013/0213904 A1
(43) Pub. Date: Aug. 22, 2013

(54) INDUSTRIAL SEPARATOR AND DEWATERING PLANT

(71) Applicants: John Christopher Mitchell, Santa Margarita, CA (US); Ken M. Stedman, Lake Forest, CA (US); Glenn Edwin Walser, Duncanville, TX (US)

(72) Inventors: John Christopher Mitchell, Santa Margarita, CA (US); Ken M. Stedman, Lake Forest, CA (US); Glenn Edwin Walser, Duncanville, TX (US)

(73) Assignee: M2 RENEWABLES, INC., Lake Forrest, CA (US)

(21) Appl. No.: 13/598,416

(22) Filed: Aug. 29, 2012

Related U.S. Application Data
(63) Continuation-in-part of application No. 13/402,531, filed on Feb. 22, 2012, now Pat. No. 8,302,780.

(51) Int. Cl. B01D 33/04

(52) U.S. Cl. 210/783; 210/400

(57) ABSTRACT

An industrial separator and dewatering plant delivers an influent to an inclined rotating filter belt for filtering out solid matter from the influent. A wash water is sprayed on the return portion of the belt to dislodge residual solid matter captured within the belt. A dewatering portion has an auger screw positioned for receiving the solid matter and the wash water. The auger screw transports the wash water and the solid matter to a compression cage where water is driven out of the solid matter by compression as it exits the plant. Alternately, the solid matter and wash water may be delivered together to a plant exit. Excess wash water is able to drain from the auger screw through a separate drain.

No federally sponsored research or development was used with respect to the apparatus and method herein described, and there is no reference to a sequence listing or table and no computer program listing or compact disc appendix is included herein.

### BACKGROUND OF THE DISCLOSURE

This disclosure relates to the field of industrial filtering plants and more particularly to such a plant that uses a continuous filter belt and an auger. Filter belts are often used to filter solid matter from an aqueous mixture. Belts commonly become clogged with the solid matter so that they require occasional or continuous cleaning or reconditioning. Keeping the belt clean is critical to efficient operation and especially for continuous operation. The prior art teaches a variety of ways for ridding filter belts of solid matter. Once the solid matter has been removed from the filter belt it is known, for instance, to mechanically extract fluid via a screw press. Hot water and steam are known to be used to heat and clean filter belts. It is known to use wash nozzles to clean raked-off or screened solid matter. The prior art teaches spraying through a continuous drag-out belt to dislodge debris. It is also known to use compressed air as the primary motive force to clean a moving filter belt. However, the prior art does not provide a solution to preventing effluent from collecting in the bottom of a processing plant. The prior art also does not provide a solution to segregating filtered water from spray-off water. Finally, the prior art also does not provide a solution to possible overflow of water within an auger screw. The present apparatus provides a solution to these difficulties.

### BRIEF SUMMARY OF THE DISCLOSURE

The presently described apparatus processes aqueous effluents to extract much of the water content leaving a semi-dry organic solid matter which has value in post processes. The process receives an effluent and first filters it to remove most of its liquid content and then compresses the remaining solid matter to extract much of the remaining water. The filtration step uses a mesh filter belt to capture the solid matter that is within the effluent, and then an auger to press much of the remaining water out of the solid matter. A wash spray is directed onto the back side of the filter belt which washes away solid matter on the front side of the filter belt, and also clears solid matter that is present within pores of the filter belt. In an auguring step, the solid matter and wash spray are compressed, which squeezes out much of the water in the mixture. A free water drain is located at one end of the auger while the solid matter is compressed and moved by the auger in the opposite direction to a compression chamber. Water of the wash spray that is not absorbed by the solid mater in the auger is free to flow above and around the auger's flights and by gravity flows toward and into the free water drain. By allowing this drainage, a liquid level in the auger is controlled so that the solid matter exiting the dewatering section is able be controlled to meet a specified moisture content.

An objective of the described apparatus and method is to prevent contamination of the filter belt.

A further objective is to reduce input energy requirements by eliminating the need for an air blower and air knife common to prior art methods.

A further objective is to provide sufficient time for gravity drainage of effluents entering the plant.

A further objective is to provide efficient filter cleaning using relatively little water in a back-spray step.

Other features and advantages will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING

Illustrated in the accompanying drawing is a best mode embodiment of the presently presented plant and its method of use. In such drawing:

FIG. 1 is an example mechanical schematic of said plant as viewed in a frontal perspective;

FIG. 2A is an example mechanical schematic thereof shown in a side perspective view with portions deleted so as to better illustrate interior features;

FIG. 2B is an example partial sectional view of a lower portion of a filter belt thereof illustrating a dewatering and filtering process;

FIG. 3 is an example mechanical schematic thereof shown in a frontal perspective view with portions deleted so as to better illustrate interior features;

FIG. 4 is an example mechanical schematic thereof shown in a rear elevational view with portions deleted so as to better illustrate interior features;

FIG. 5 is an example mechanical schematic of a dewatering device thereof shown in an exterior perspective;

FIG. 6 is an example mechanical schematic perspective view of FIG. 5 with portions removed to better illustrate interior features; and

FIG. 7 is an example block diagram illustrating a method of operation of the plant.

Like reference symbols in the various figures indicate like elements.

### DETAILED DESCRIPTION OF THE INVENTION

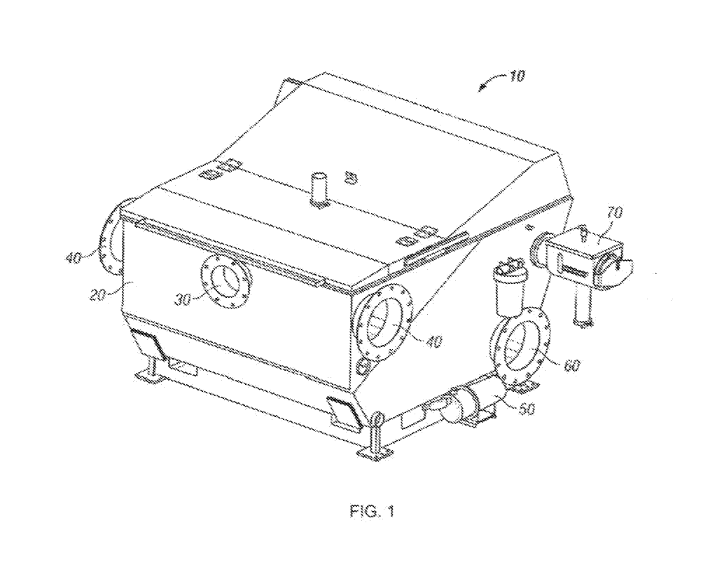

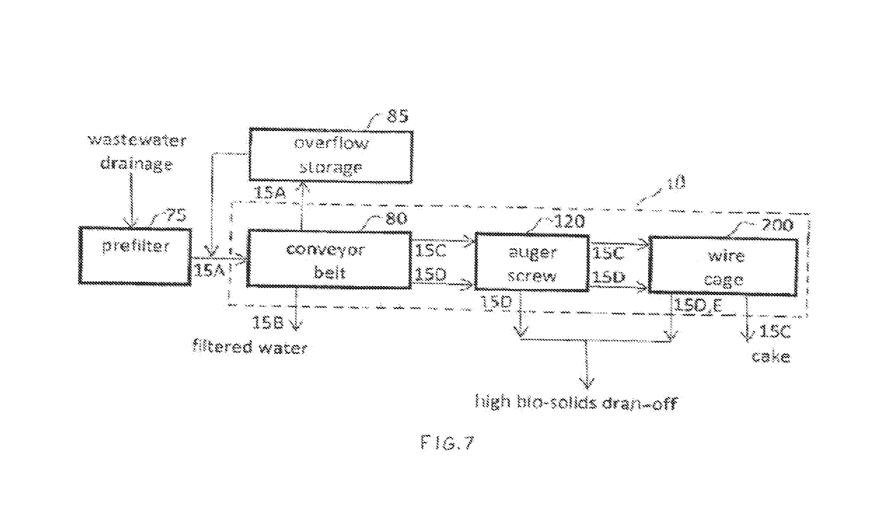

FIG. 1 illustrates an industrial separator and dewatering plant 10 used for processing an effluent 15A; see FIG. 7. Components of plant 10 are supported within and attached externally to a structural enclosure 20. Locations of a plant: inlet 30 for receiving the effluent 15A, effluent overflow outlets 40, wash water pump 50, outlet 60 for filtered water 15B, and dewatering device 70 are shown. Techniques for joining in-feed and out-feed conduits to elements 30, 40 and 60 are well known in the art.

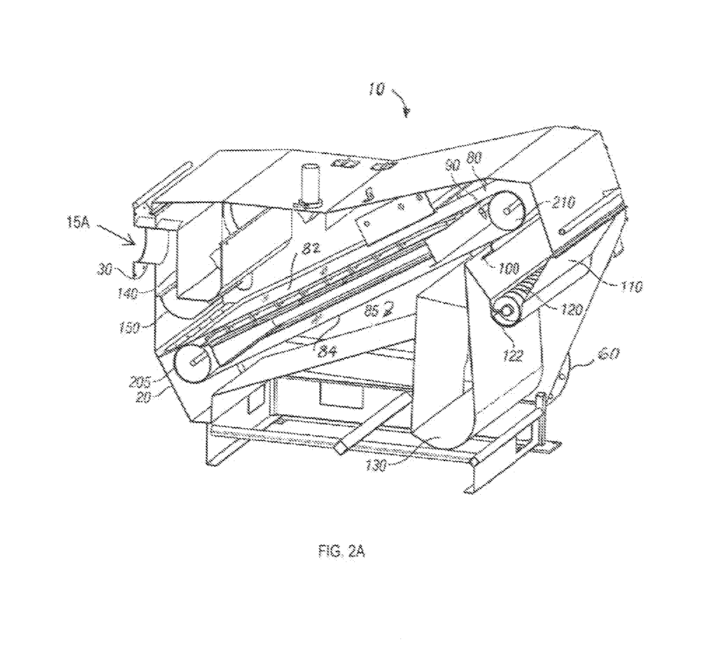

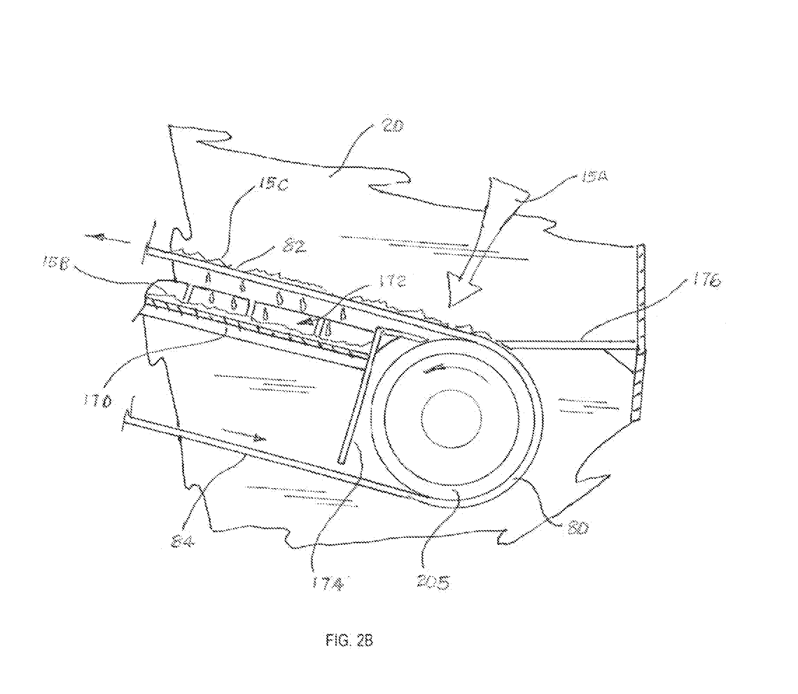

FIG. 2A shows locations of a filter belt 80 supported by a bottom 205 and a top 210 rollers, the filter belt 80 being a fine mesh filter which has an upper belt portion 82 moving above a lower belt portion 84. Also shown are: filter cavity 85 within which filter belt 80 operates, spray wash nozzle(s) 90, belt scraper 100, solid matter collection basin 110, auger 120, collection manifold 130, diverter panel 140, and catch shelf 150. Effluent inlet 30 is shown at the left in FIG. 2A.

FIG. 2B shows filter belt 80 as it moves around lower pulley 205 and carries effluent 15A on upper belt portion 82 upwardly to the left with filtered water 15B shown dripping through upper belt portion 82 onto diverter pan 170 and flowing through window 172. A lower dam plate 174 prevents filtered water 15B from reaching lower pulley 205 and lower belt portion 84. An upper dam plate 176 is positioned to prevent incoming effluent 15A, illustrated by a large arrow, from flowing past filter belt 80. Solid matter 15C remains on and within upper belt portion 82 and is carried upwardly.

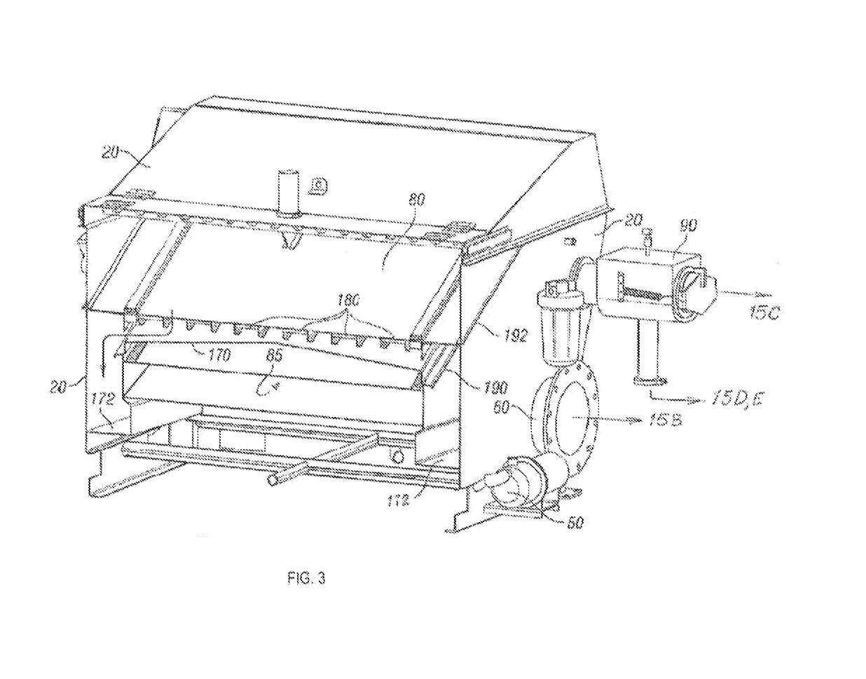

FIG. 3 shows locations of the diverter pan 170 which, for clarity, is not shown in FIG. 2A, framework ribs 180 which support upper belt portion 82, and rubber gasket seals 190 and 192 which constrain filtered water 15B so it can be secured without being contaminated by solid matter 15A after passing onto pan 170. Portions of the enclosure 20, the filter belt 80, the filter cavity 85, and also the wash water pump 50 and the filtered water outlet 60 are also shown in FIG. 3.

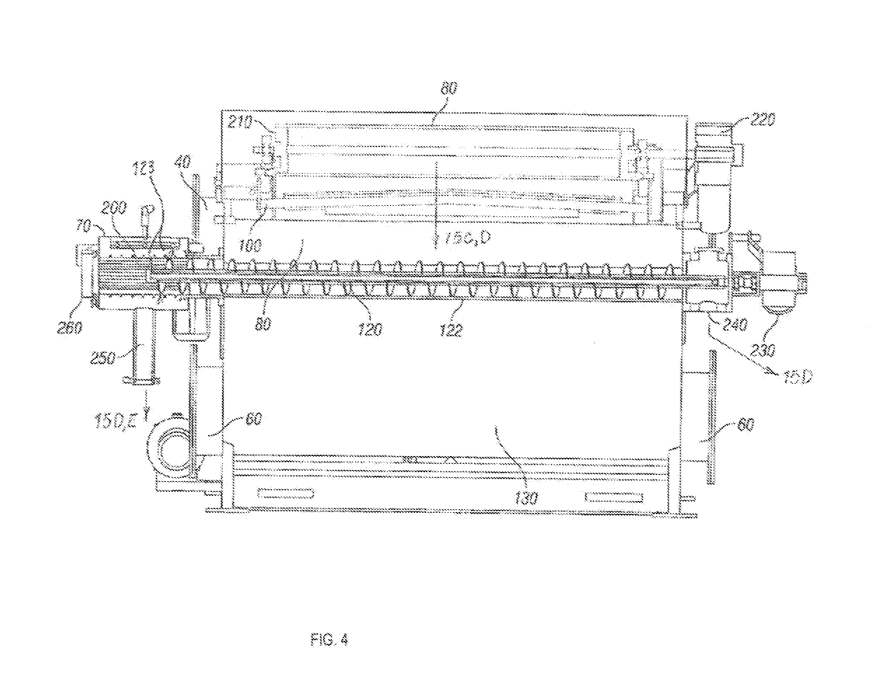

FIG. 4 shows locations of a cylindrical wire cage 200, the top roller 210 which is shown in cross-section, a belt drive 220 for the filter belt 80, an auger drive 230, an auger overflow drain 240 for releasing wash water 15D, a dewatering drain 250 for receiving wash water 15D and extracted water 15E, and a compression door 260. FIG. 4 also shows: the effluent overflow outlet 40, filtered water collection basin 130, filtered water outlets 60, and belt scraper 100.

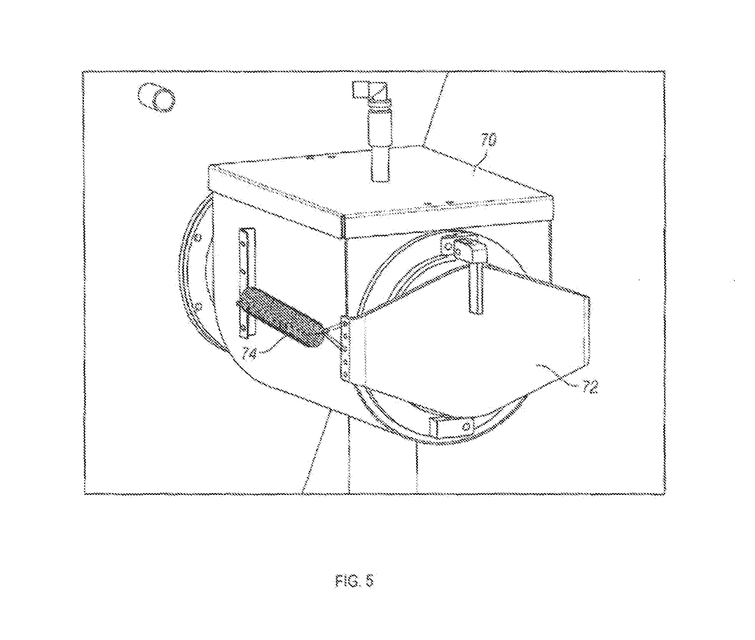

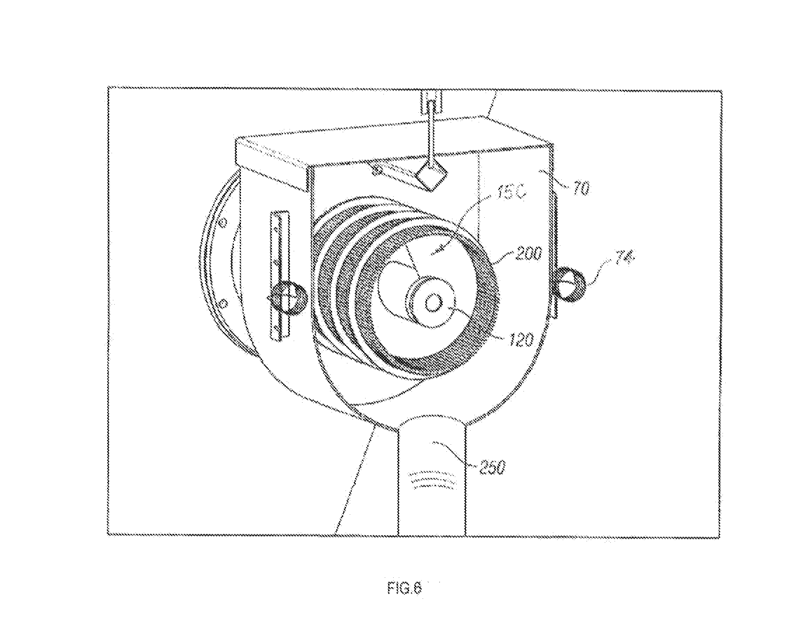

FIG. 5 shows the dewatering device 70 with its compression door 72 and one of its engaging springs 74. FIG. 6 shows interior details of the dewatering device 70 including the wire cage 200, auger 120, and dewatering drain 250.

Plant 10 separates and dewaters effluent 15A entering plant 10 at inlet 30. Effluent 15A may have a total suspended solids (TSS) in the range of from about 100 to 2,000 mg/L. The effluent 15A may be collected from a typical municipal sewage system which might have about 300 mg/L TSS. Effluent 15A may also originate from any other industrial process or source. As shown in FIG. 7, trash, garbage and other materials usually found in an effluent drainage may be separated using a pre-filter 75. Downstream of pre-filter 75 effluent 15A enters plant 10 at inlet 30 where it encounters diverter panel 140 dropping onto catch shelf 150 whereupon it spills onto filter belt 80 as shown in FIG. 2B. The diverter panel 140 and catch shelf 150 shown in FIG. 2 direct the incoming effluent 15A to filter belt 80 while absorbing most of its incoming kinetic energy. When the inflow of effluent 15A is in excess of what belt 80 is able to accommodate, it flows out of effluent overflow outlets 40 shown in FIG. 1 and into an overflow storage tank 85 shown in FIG. 7 and may be returned to plant 10 later through inlet 30. The filter belt 80 is made of a filter mesh material of a fineness selected for capturing a desired degree of the TSS carried by effluent 15A. Once on filter belt 80 effluent 15A drains by gravity through the top portion 82 of filter belt 80 and, as shown in FIG. 2, falls onto diverter pan 170 and from there into alleys 172 and collection manifold 130 to then leave plant 10 via outlets 60 as filtered water 15B. Gravity drainage continues during the entire time effluent 15A rides on belt 80, that is, as belt 80 moves upward.

Solid matter 15C is left behind on and in filter belt 80 and comprises between 40-90% of the TSS of the effluent 15A depending on the type and fineness of the filter material of which filter belt 80 is made. Filter belt 80 moves continuously as an inclined rotating linear filter. Both upper 82 and lower 84 portions of belt 80 may be planar and may move in parallel with each other in opposite directions and over spaced apart top roller 210 and bottom roller 205 (FIGS. 2A and 2B).

As belt 80 moves over top roller 210 some portion of solid matter 15C may fall into collection basin 110 and therefore into auger screw 120 as best illustrated in FIG. 2. As belt 80 starts to move downward a high pressure low volume spray is delivered from one or more nozzles 90 against the inside of the lower belt portion 84 of belt 80 where further solid matter 15C is washed into collection basin 110. Subsequently residue of the solid matter 15C is dislodged by scraper 100 and falls also into collection basin 110. Solid matter 15C and wash water 15D is collected in auger screw 120 and conveyed thereby to the wire cage 200 as best shown in FIG. 4, and as described below. Scraper 100 is in position to deflect overspray of wash water 15D so that it enters collection basin 110.

Solid matter 15C and wash water 15D are carried by auger screw 120 to the left in FIG. 4 into wire cage 200 as described above, where wash water 15D drains into dewatering drain 250. Solid matter 15C is compacted by auger screw 120 where most of its water content 15E is extracted. Brushes 123 attached to, and extending outwardly from the flights of auger screw 120 keep the approximately 1 mm gaps between adjacent wires of the wire cage 200 clear so that extracted water 15E may flow freely out of wire cage 200 and into dewatering drain 250.

Overflow drain 240, located at the right end of auger screw 120 in FIG. 4 removes excess wash water 15D within auger screw 120 when the level of such water rises high enough to flow around auger flights of auger screw 120 which keeps the screw 120 from flooding.

With the water extraction step described above, solid matter 15C is converted to a semi-solid consistency which passes out of plant 10 though door 72 when pressure within the wire cage 200 is sufficient to push open door 72 against tension springs 74. The solid matter 15C may have a water content of between only 50% and 60%.

The auger screw 120 is mechanically rotated within auger trough 122 by an electric auger drive motor 230, as shown in FIG. 4. A further drive 220 of belt 80 is also shown in FIG. 4. As shown, auger trough 122 is open above auger screw 120 so that solid matter 15C and wash water 15D may freely fall into it from belt 80. Wash water 15D and extracted water 15E may be jointly collected into a common manifold outside of plant 10 and may have between 1500 and 5000 mg/L TSS. There are commercial uses for this water because of its high concentration of biological matter.

Embodiments of the subject apparatus and method have been described herein. Nevertheless, it will be understood that various modifications may be made without departing from the spirit and understanding of this disclosure. Accordingly, other embodiments and approaches are within the scope of the following claims.

1-20. (canceled)

21. A plant for separating and dewatering wastewater, the plant comprising:
an enclosure;
an inclined rotating conveyor belt of filter material disposed within the enclosure, the conveyor belt encircling a lower pulley and an upper pulley;
a wastewater inlet in a wall of the enclosure for delivering the wastewater onto an upper portion of the conveyor belt, wherein a filtered water from the wastewater flows through the conveyor belt leaving a cake on and in the conveyor belt;
a spray nozzle mounted within the enclosure between the upper portion and a lower portion of the conveyor belt, the spray nozzle positioned for directing a wash water toward the lower portion of the conveyor belt for washing the cake off the lower portion of the conveyor belt;
an auger screw positioned below the conveyor belt in a position for receiving the cake and the wash water from the conveyor belt;
a pair of drains positioned at opposing ends of the auger screw; and
a pair of dam plates positioned adjacent to the lower pulley, one of the dam plates being substantially horizontally mounted to the enclosure for directing the wastewater onto the upper portion of the conveyor belt, and the other of the dam plates extending longitudinally between the lower portion and the upper portion of the conveyor belt for directing the filtered water into an alley within the enclosure for exiting the plant.

22. The plant of claim 21 further comprising a wire cage positioned at one end of the auger screw, the wire cage in fluid communication with bristles on the auger screw, the bristles in positions for maintaining spaces between wires of the wire cage thereby assuring liquid flow therethrough.

23. The plant of claim 22 further comprising a spring loaded door adjacent the wire cage for directing the cake out of the plant by a directed force from the auger screw.

24. The plant of claim 21 further comprising a belt scraper in contact with the lower portion of the conveyor belt in a position for removing the cake therefrom and for directing the cake into the auger screw and for deflecting wash water overspray into the auger screw.

25. The plant of claim 21 further comprising a diverter panel and a catch shelf positioned within the plant adjacent the wastewater inlet for enabling a reduction of wastewater kinetic energy.

26. A method for separating and dewatering wastewater, the method comprising:
rotating an inclined conveyor belt of filter material within an enclosure;
delivering the wastewater through an inlet in a wall of the enclosure onto an upper portion of the conveyor belt, wherein a filtered water from the wastewater flows through the conveyor belt leaving a cake on and in the conveyor belt;
directing a wash water from a spray nozzle mounted between the upper portion and a lower portion of the conveyor belt, toward the lower portion of the conveyor belt thereby washing the cake off the lower portion of the conveyor belt;
receiving the cake and the wash water from the conveyor belt in an auger screw positioned below the conveyor belt;
delivering cake and wash water into a pair of drains positioned at opposing ends of the auger screw; and
directing the wastewater onto the conveyor belt using a first dam plate and directing the filtered water to an alley within the enclosure for exiting the plant using a second dam plate.

27. The method of claim 26 further comprising maintaining spaces between wires of a wire cage using bristles of the auger thereby assuring liquid flow through the wire cage.

28. The method of claim 27 further comprising compressing the cake between a spring loaded door and the auger.

29. The method of claim 26 further comprising scraping the cake off the conveyor belt and directing the cake into the auger and further deflecting wash water overspray into the auger.

30. The method of claim 26 further comprising positioning panels within the enclosure adjacent to the wastewater inlet thereby reducing kinetic energy of the wastewater.

31. A plant for separating and dewatering a liquid fluid, the plant comprising:
an enclosure having an inclined belt of filter material;
an inlet for delivering the liquid fluid into the plant, a first dam plate positioned for directing the liquid fluid onto the belt wherein a filtered water from the liquid fluid flows through the belt leaving a cake on the belt;
a spray nozzle positioned for directing a wash water toward the belt for washing the cake off the belt;
a transport positioned below the belt in a position for receiving the cake and the wash water;
at least one drain positioned adjacent at least one of opposing ends of the transport for directing the cake and the wash water out of the plant; and
a second dam plate positioned below the belt for receiving and directing the filtered water out of the plant.

32. The plant of claim 31 further comprising a porous cage positioned adjacent an end of the transport, the porous cage in fluid communication with bristles of the transport, the bristles in position for maintaining open spaces of the porous cage thereby assuring liquid flow through the porous cage.

33. The plant of claim 32 further comprising a flow restriction positioned and enabled for restricting flow of the cake from the transport.

34. The plant of claim 31 further comprising a belt scraper in contact with the belt in a position for removing the cake therefrom and for directing the cake into the transport and for deflecting wash water overspray into the transport.

35. The plant of claim 31 further comprising a means for reducing a kinetic energy of the liquid fluid entering the plant.

36. A method for separating and dewatering a liquid fluid, the method comprising:
delivering the liquid fluid onto an inclined belt wherein a filtered water from the liquid fluid flows through the belt leaving a cake on the belt;
directing a wash water toward the belt and washing the cake off the belt;
receiving the cake and the wash water in a transport;
directing the cake and the wash water out of the plant through at least one drain;
positioning a dam plate below the belt thereby collecting the filtered water.

37. The method of claim 36 further comprising positioning a porous cage adjacent an end of the transport, placing the porous cage in fluid communication with bristles of the transport, and maintaining open spaces of the porous cage thereby assuring liquid flow through the porous cage.

38. The method of claim 37 further comprising restricting flow of the cake from the transport.

39. The method of claim 36 further comprising scraping the cake from the belt and directing the cake into the transport and deflecting wash water overspray into the transport.

40. The method of claim 36 further comprising reducing kinetic energy of the liquid fluid entering the plant.
